(19) United States
(12) Patent Application Publication
(10) Pub. No.: US 2015/0205540 A1
(43) Pub. Date: Jul. 23, 2015

(54) MEMORY SYSTEM INCLUDING NONVOLATILE MEMORY DEVICES AND OPERATING METHOD

(71) Applicant: SAMSUNG ELECTRONICS CO., LTD, Suwon-si (KR)

(72) Inventors: SANG-WOOK YOO, SEONGNAM-SI (KR); PILCHANG SON, SUWON-SI (KR); JOON-HO LEE, HWASEONG-SI (KR)

(21) Appl. No.: 14/447,654

(22) Filed: Jul. 31, 2014

(30) Foreign Application Priority Data
Jan. 22, 2014 (KR) 10-2014-0007836

(51) Int. Cl. G06F 3/06

(52) U.S. Cl. CPC G06F 3/0625; G06F 3/0688; G06F 3/0656

(57) ABSTRACT

A memory system includes nonvolatile memory devices (NVM) connected to a controller via a channel and provided with data according to an interleaving approach. A controller respectively accesses the NVM and determines a number of program operations that may be simultaneously executed by the NVM in conjunction with an additional operation upon comparing a peak operating current associated with a sum of respective peak operating currents for the number of program operations and the at least one additional operation with a reference peak current.

### CROSS-REFERENCE TO RELATED APPLICATIONS

A claim for priority under 35 U.S.C. §119 is made to Korean Patent Application No. 10-2014-0007836 filed Jan. 22, 2014, the subject matter of which is hereby incorporated by reference.

### BACKGROUND

The inventive concept described herein relates generally to memory systems, and more particularly, memory systems including a nonvolatile memory device(s), as well as operating methods for same.

Semiconductor memory devices may be classified as volatile or nonvolatile in their operative nature. Read and write speeds for volatile memory device are relatively fast but stored data is lost in the absence of applied power. In contrast, nonvolatile memory devices retain stored data in a power-off condition.

With advances in design and fabrication technologies, flash memory—one particular type of nonvolatile memory—enjoys lower price points and superior performance advantages. Thus, flash memory is being used as a storage medium for replacing a hard disk drive (HDD). Certain storage devices using the flash memory device may be variously fabricated. Such storage devices may be used as a solid state drive (SSD), an SD card, and so on. The storage device contains a controller to control the flash memory device. In recent years, an operating frequency and a level of integration associated with flash memory devices has increased. As a result, the controller includes additional function such as error correction capabilities that ensure greater data reliability. These additional feature, however, tend to drive up overall current consumption and peak operating currents.

### SUMMARY

In one embodiment, the inventive concept provides a memory system including; a plurality of nonvolatile memory devices (NVM) commonly connected to a controller via a channel, each NVM being configured to receive write data from the controller according to an interleaving approach and to independently execute a program operation with respect to other ones of the NVM, wherein the controller is configured to respectively access the NVM according to the data interleaving approach and to control the execution of program operations by the NVM, the controller is further configured to determine a number of the program operations that are to be simultaneously executed by the NVM in conjunction with at least one additional operation upon comparing a peak operating current associated with a sum of respective peak operating currents for the number of program operations and the at least one additional operation with a reference peak current.

In another embodiment, the inventive concept provides an operating method for a memory system including a controller and a plurality of nonvolatile memory devices (NVM) commonly connected to the controller having a peak current manager via a channel. The method includes; receiving from a host a sequence of copy-back operations in the controller, wherein each one of the copy-back operations is directed to data stored in an interleaved manner across the plurality of NVM, and includes a read operation, data output operation, a data input operation and a data program operation, and using the peak current manager to determine a number of program operations associated with the sequence of copy-back operations that will be simultaneously executed by the plurality of NVMs in conjunction with at least one additional operation by summing respective peak operating currents for the number of program operations and a peak operating current for the at least one additional operation to generate a peak operating current, and thereafter comparing the peak operating current to a reference peak current.

In another embodiment, the inventive concept provides an operating method for a memory system including a controller and nonvolatile memory devices (NVM) commonly connected to the controller having a peak current manager via a channel. The method comprises; receiving from a host a sequence of operations to be executed by the controller in the NVM, using the peak current manager to determine a number of operations from among the received sequence of operations that will be simultaneously executed by the NVMs in view of a peak operating current equal to a sum of peak operating currents for each one of the number of operations and further in view of a reference peak current.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a memory system according to an embodiment of the inventive concept;

FIG. 2 is a block diagram schematically illustrating a controller shown in FIG. 1, according to an embodiment of the inventive concept;

FIG. 3 is a block diagram schematically illustrating nonvolatile memory devices controlled by a flash interface in FIG. 2 and a memory channel;

FIG. 4 is a timing diagram schematically illustrating a copy operation of a memory system according to a general interleaving manner;

FIG. 5 is a diagram schematically illustrating a peak current according to each operation of a memory system shown in FIG. 1;

FIG. 6 is a timing diagram schematically illustrating a copy-back method of a memory system according to an embodiment of the inventive concept;

FIG. 7 is a timing diagram schematically illustrating a copy-back method of a memory system according to another embodiment of the inventive concept;

FIG. 8 is a timing diagram schematically illustrating a copy-back method of a memory system according to still another embodiment of the inventive concept;

FIG. 9 is a flow chart schematically illustrating a copy-back operation of a memory system according to an embodiment of the inventive concept;

FIG. 10 is a timing diagram schematically illustrating a write method of a memory system according to a typical interleaving manner;

FIG. 11 is a timing diagram schematically illustrating a write method of a memory system according to an embodiment of the inventive concept;

FIG. 12 is a block diagram illustrating a memory system according to another embodiment of the inventive concept;

FIG. 13 is a block diagram illustrating a solid state drive according to an embodiment of the inventive concept;

FIG. 14 is a block diagram schematically illustrating a memory card according to an embodiment of the inventive concept; and

FIG. 15 is a block diagram schematically illustrating a computing system according to an embodiment of the inventive concept.

### DETAILED DESCRIPTION

Embodiments of the inventive concept will now be described in some additional detail with reference to the accompanying drawings. The inventive concept, however, may be embodied in various different forms, and should not be construed as being limited to only the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Hereafter, certain memory systems including a nonvolatile memory device(s) will be used as examples of a broad range of data storage devices and/or electronic devices contemplated by the inventive concept. Those skilled in the art will understand that other features and aspects susceptible of incorporation by the inventive concept from exemplary embodiments described herein. For example, NAND flash memory devices are described hereafter as a storage medium, but other types of nonvolatile memory might be alternately or additionally used. For example, phase-change Random Access Memory (or RAM) (PRAM), magnetic RAM (MRAM), resistive RAM (ReRAM), Ferro-magnetic Ram (FRAM), or other types of flash memory might alternating or additionally be incorporated in memory systems according to the inventive concept.

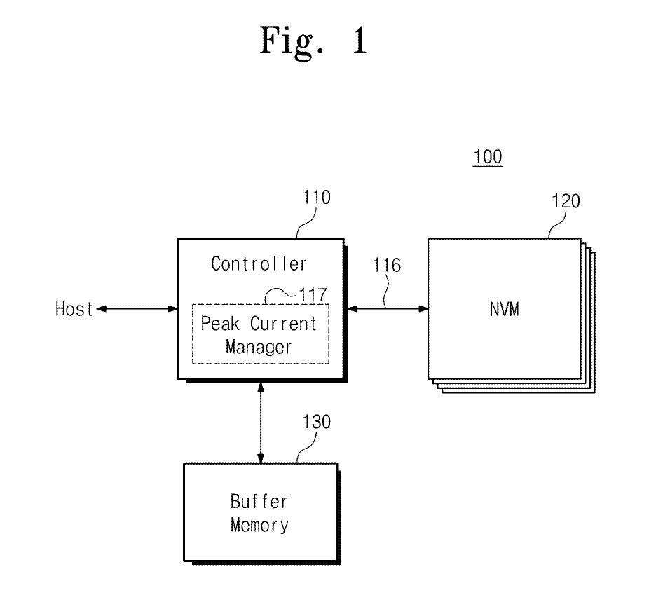

FIG. 1 is a block diagram illustrating a memory system 100 according to an embodiment of the inventive concept. Referring to FIG. 1, the memory system 100 generally comprises; a controller 110, nonvolatile memory devices 120, and a buffer memory 130. The memory system 100 is configured to exchange data with a host (not shown) via an input/output (I/O) port. In this capacity, the controller 110 receives “write data” (i.e. data to be written to the nonvolatile memory devices 120) from the host and causes the write data to be stored in nonvolatile memory devices 120 in response to a write request also received from the host. Analogously, the controller 110 will retrieve identified “read data” (i.e. data already stored in the nonvolatile memory devices 120) from the nonvolatile memory devices 120 in response to a read request received from the host.

Thus, the controller 110 provides collection of physical connection(s) between the host and the memory system 100, or more particularly, an interface between the memory system 100 and host using one of several possible bus format(s) and/or data communication protocols. In certain embodiments of the inventive concept, the controller 110 may be used to drive firmware controlling the operation, wholly or in part, of the memory system 100. Such firmware may include a peak current manager 117, wherein the controller 110 may be used to change (or alter) the occurrence (or periodic occurrence) of certain operating points associated with the controller 110 and/or the nonvolatile memory devices 120 using the peak current manager 117.

For example, the controller 110 may be used to compare a peak operating current (Iop) with a peak reference current (Iref) in order to determine a “next operation” to be performed. The peak operating current (Iop) may be defined as a sum of peak currents associated with various operations being simultaneously executed by the controller 110 and nonvolatile memory devices 120. Thus, in certain embodiments of the inventive concept, the peak current manager 117 will store (or may otherwise be capable of referencing) “peak current information” associated with the variety of operations executed by the controller 110 and/or the nonvolatile memory devices 120. In such configurations, the controller 110 is able to compare one value (i.e., calculated or derived from peak current information, and/or physically measured) for the peak operating current (Iop) with another value for the peak reference current (Iref).

“Present current consumption” for the memory system 100 may be defined as a sum of the electrical current being consumed by the controller 110, and the electrical current being consumed by the nonvolatile memory devices 120 at any given point in time. Thus, peak operating current (Iop) for the memory system 100 depend on exactly which operations are allowed to be simultaneously executed by the controller 110 and the nonvolatile memory devices 120. The decisions of “how many?” and “which?” operations may be simultaneously executed is made by the controller 110 using peak current manager 117. By intelligently determining which and how many operations should be performed over respective time periods, the level of present current consumption may be maintained well below a maximum value for peak operating current for the memory system 100.

In the memory system 100 of FIG. 2, a number of NAND flash memory devices are assumed as the nonvolatile memory devices 120, and the controller 110 is respectively connected to each one of the nonvolatile memory devices 120 via a channel 116. Those skilled in the art will understand that the channel 116 may be variously configured (e.g., into a plurality of sub-channels).

In relation to the memory system 100 of FIG. 1, it is further assumed that the plurality of NAND flash memory devices 120 are connected to the channel 116 which includes a commonly connected data bus. Thus, each one of the NAND flash memory devices 120 connected to the controller 110 via the channel 116 may be used in an interleaved manner, where one of many different interleaving approaches may be defined according to data size, the number of NAND flash memory devices 120, channel access speeds, the number of “ways” interconnecting the channel and the NAND flash memory device 120, etc.

The buffer memory 130 may be used to temporary store incoming “write data” received from the host, or outgoing “read data” being communicated to the host from the nonvolatile memory devices 120. In the event that read data identified by a read request received from the host is currently cached in the nonvolatile memory devices 120, it may be directly read from the buffer memory 130 and provided to the host. Typically, data transfer speeds (e.g., those established by the SATA or SAS standards) between the host and the controller 110 will be much higher than data transfer speeds between the memory controller 110 and the nonvolatile memory devices 120. Accordingly, a large capacity buffer memory 130 may be used to good advantage by precluding degradations in data throughput due to the inherently slower data access speeds provided by the memory system 100.

In certain embodiments of the inventive concept, the buffer memory 130 may be implemented as a synchronous dynamic Ram (DRAM) to provide sufficient buffering to the memory system 100 when used (e.g.,) as an auxiliary mass storage device.

With the above-described features, the memory system 100 of FIG. 1 is capable of receiving a sequence of “access requests” (e.g., write requests and “read requests”) for data to be stored in or data currently stored in the nonvolatile memory devices 120. In this regard, the memory system 100 is also capable of continuously comparing peak operating current (Iop) with a reference peak current (Iref). In order to reduce the maximum peak current that the memory system 100 must be subjected to in response to requests made by one or more host(s), the controller 110 of FIG. 1 may be used to intelligently determine which and how many operations may be simultaneously executed in relation to the nonvolatile memory devices 120 based on the comparison result between peak operating current (Iop) and reference peak current (Iref). In this manner it is possible to more rationally bound the range of maximum instant current consumption demands placed upon the constituent components of the memory system 100.

FIG. 2 is a block diagram further illustrating in one example the controller 110 of FIG. 1. Referring to FIGS. 1 and 2, the controller 110 generally comprises a central processing unit (CPU) 111, a working memory 112, a host interface (I/F) 113, a buffer manager 114, and a flash interface (I/F) 115.

The CPU 111 controls the overall operation of the controller 110. The CPU 111 may be configured to drive firmware controlling the operation, wholly or in part, of the controller 110. In certain embodiments of the inventive concept, the firmware may include the peak current manager 117. The CPU 111 may be used to decode a stream of commands, control signals and/or instructions associated with various data access requests received from a host. Then, the CPU 111 may be used to control operation of and/or inter-operation of the host I/F 113, buffer manager 114, working memory 112, and/or the I/F 115 in a manner consistent with the execution of one or more currently executed operations (e.g., a write operation, read operation, etc.).

In this regard, the CPU 111 may be used to “order” or ‘reorder” a corresponding “sequence of execution” for a sequence of the operations received from the host. Operation ordering and reordering made be defined by the CPU 111 is view of made of the processing capacity (or residual processing capacity) of the controller 110 and/or nonvolatile memory devices 120, and further in view of the current consumption information provided by the peak current manager 117. In other words, the CPU 111 may be used to control (or “select’) the number and/or type of operations being simultaneously executed by the controller 110 and the nonvolatile memory devices 120. At least in part, the CPU 111 may control this dynamic “current loading” of the memory system 100 by comparing a current peak operating current (Iop) with a reference peak current (Iref) in order to whether a next operation should be added to the group of operations currently being executed, and/or which pending operation should be selected as the next operation.

As noted above, the derivation of “current peak operating current” made be made in the memory system 100 using the controller 110 by actually measuring the current peak operating current (or some portion thereof) and/or deriving or calculating the current peak operating current using peak current information associated with a variety of operations executable by the memory system 100 or one or more components of the memory system 100. The peak current manager 117 may be used in this regard, and may more specifically be used to store (or reference) peak current information.

The host I/F 113 may be used to provide a physical connection between the host and memory system 100. That is, the controller 110 in conjunction with the host I/F 113 may be used to provide an interface between the memory system 100 and the host. Any one of a number of conventionally understood data communication protocols might be used, such as USB (Universal Serial Bus), SCSI (Small Computer System Interface), PCI express, ATA, PATA (Parallel ATA), SATA (Serial ATA), SAS (Serial Attached SCSI), and the like.

Also, the host I/F 113 may support a disk emulation function that enables the host to recognize the memory system 100 as a legacy hard disk drive (HDD). That is, the host I/F and CPU 111 may combine to provide a flash translation layer (FTL) capable of hiding certain erase operations executed by the nonvolatile memory devices 120.

The buffer manager 114 may be used to control read and write operations directed to data stored in (or to be stored in) the buffer memory 130. For example, the buffer manager 114 may temporarily store write data received from the host in the buffer memory 130, and/or temporarily stores read data retrieved from the nonvolatile memory devices 120 in the buffer memory 130.

The flash I/F 115 may be used to control the exchange of data between the nonvolatile memory devices 120 and the CPU 11 and/or buffer memory 113. The flash I/F 115 may further facilitate the connection of the nonvolatile memory devices 120 to the controller 110 via a channel, a plurality of channels, or plurality of sub-channels (hereafter, singularly or in combination referred to as “the channel 116” regardless of particular architecture). The flash I/F 115 may thus be used to communicate data from the buffer memory 130 to the nonvolatile memory devices 120 via the channel 116. Read data obtained from the nonvolatile memory devices 120 via the channel 116 may thereafter be communicated to the buffer memory 130 via the flash I/F 115.

During write and read operations for example, the flash I/F 115 may be establish a read/write “data distribution order” controlling the writing of data or the retrieval of data across a plurality of nonvolatile memory devices 120 connected via the channel 116 under the control of the CPU 111. Thus, the flash I/F 115 may access the plurality of nonvolatile memory devices 120 in one or more data distribution orders in order to facilitate a particular data interleaving approach. As previously noted, many different data interleaving approaches may be used in the context of the inventive concept, depending (e.g.,) on memory system constraints, data type, and data volume. However, in many embodiments of the inventive concept, the flash I/F 115 may be used to implement error detection and/or error correction functionality. Thus, the flash I/F 115 may include, wholly or in part, an ECC circuit and/or related ECC software components.

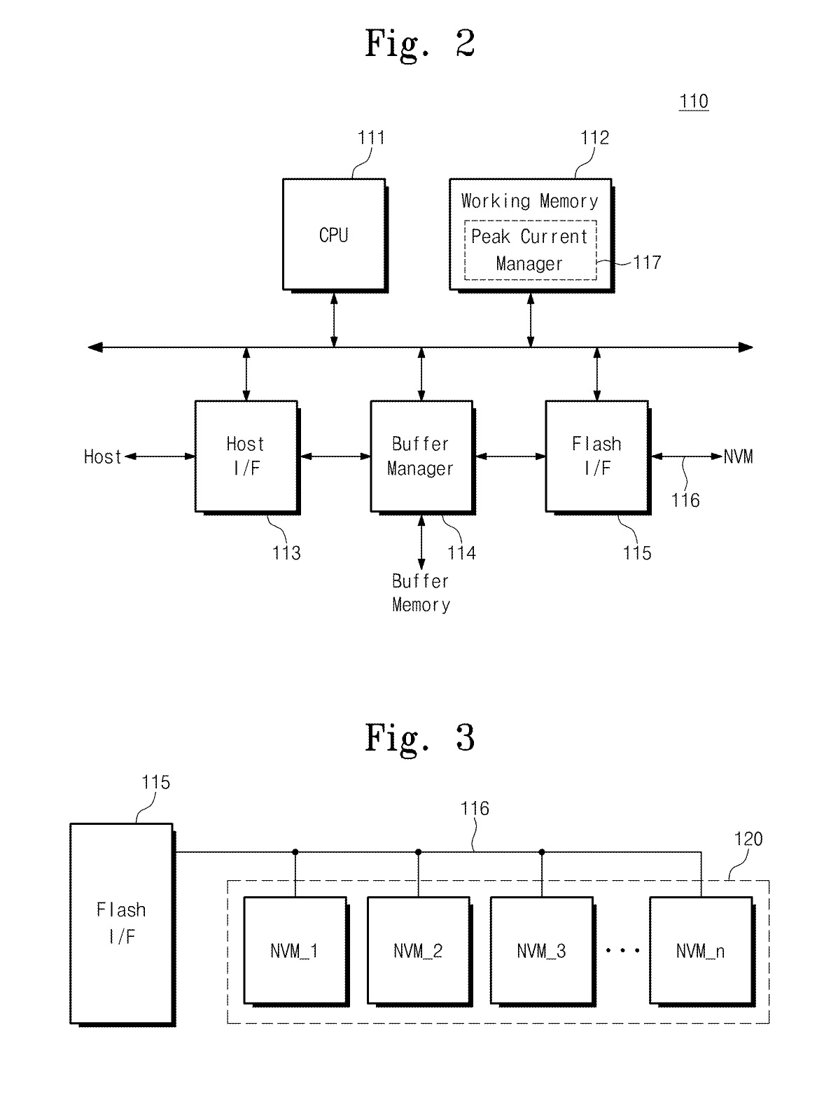

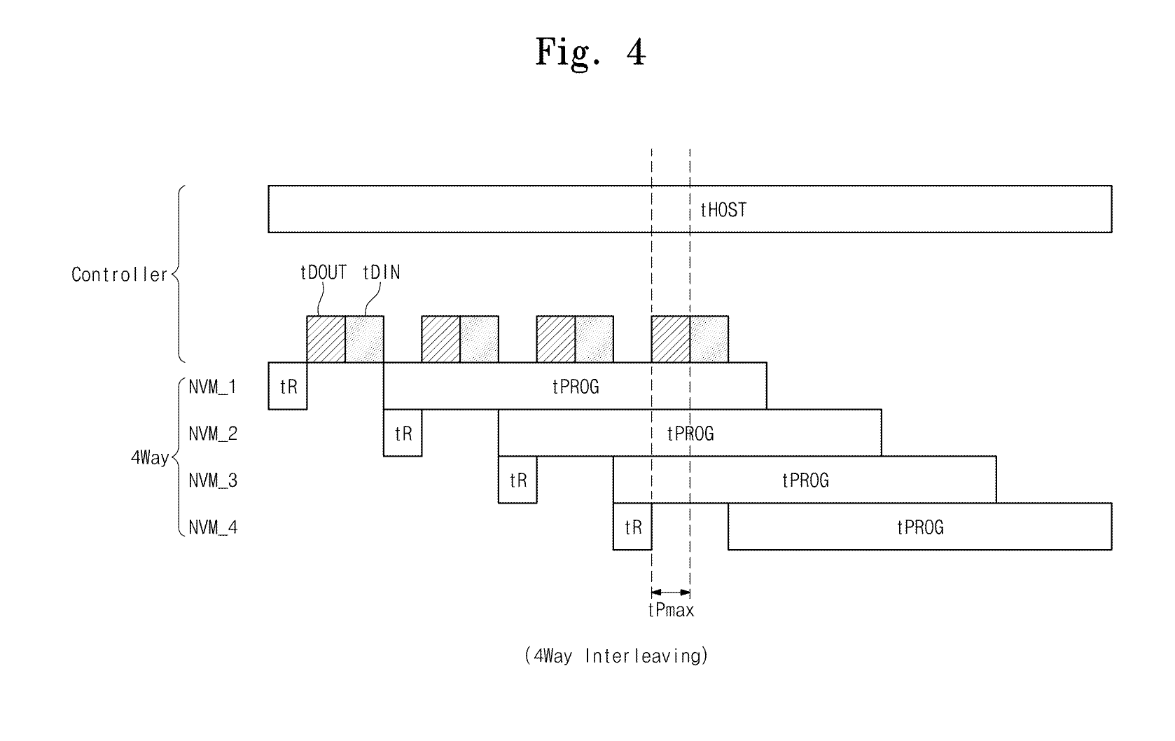

FIG. 3 is a block diagram illustrating in one example the nonvolatile memory devices 120 and flash interface (I/F) 115 of FIG. 2 in the context of the channel 116. Referring to FIG. 3, the flash I/F 115 may be used to connect the nonvolatile memory devices 120 via the channel 116. However, the inventive concept is not limited to only this type of channel connection.

The flash I/F 115 may also be used to determines a nonvolatile memory device (“NVM”) access order for the nonvolatile memory devices 120 under the control of the CPU 111. For example in FIG. 3, the nonvolatile memory devices 120 include ‘n’ memory devices NVM_1 through NVM_n. Respective I/O ports (e.g., respective I/O ports implemented by eight (8) I/O pins) for the memory devices NVM_1 to NVM_n are connected with the channel 116.

The flash I/F 115 is assumed to provide a selective access to the memory devices NVM_1 through NVM_n, such that a data interleaving approach may be implemented. The flash interface 115 is still further assumed to provide an ECC circuit to detect/correct one or more errors arising in the write/read data being communicated.

FIG. 4 is a conceptual timing diagram illustrating the simultaneous execution of multiple copy-back operations in the memory system 100 of FIG. 1 when managed by a general interleaving approach. Referring to FIGS. 1, 2, 3 and 4, certain sequentially requested operations are at least partially execution in an overlapping manner by the operational combination of the controller 110 and nonvolatile memory devices 120. In the illustrated example, it is assumed that four (4) nonvolatile memory devices 120 include memory devices NVM_1 through NVM_4. Hence, it is assumed that the flash I/F 115 controls the four (4) memory devices NVM_1 to NVM_4 using a 4-way interleaving approach.

Under these assumptions, the controller 110 is assumed to sequentially receive a first write (or program) request and corresponding first write data from the host. Then, a host transmission and reception operation (Host_op) between the controller 110 and host may be generated at any time, or not. In a worst case, the host transmission and reception operation (Host_op) may be performed during all periods of a given time. The host transmission and reception operation (Host_op) may be executed during a host transmission and reception period (tHOST).

The copy-back operation being executed in relation to a first memory device NVM_1 may include a read operation, a data output operation, a data input operation, and a program operation. During the read operation, data is read from the memory device NVM_1 and stored in a buffer memory associated with the first memory device NVM_1. Then, the read operation is performed during a read period tR.

Next, during the data output operation, the data stored in the buffer memory associated with the first memory device NVM_1 is transferred to the buffer memory 130 of the controller 110. An error checking and correction (ECC) operation is executed while data stored in the buffer of the memory device NVM_1 is transferred to the buffer memory 130. In conjunction with this step, the controller 110 may perform additional operations such as the ECC operation. Accordingly, the data output operation may cause a large amount of current consumption, while being executed during the data output period tDOUT.

Next, during the data input operation, data stored in the buffer memory 130 by the data output operation is communicated back to the buffer memory associated with the first memory device NVM_1. The data input operation is performed during the data input period tDIN indicated in FIG. 4.

Finally, during the program operation, the data temporarily stored in the buffer memory associated with the first memory device NVM_1 may be programmed to a given block of the first memory device NVM_1, the block having been previously erased. In the example of FIG. 4, the program operation commences only after the data input operation has ended and is performed during a program period tPROG.

Like the first copy-back operation executed in relation to the first memory device NVM_1, second, third and fourth copy-back operations respectively executed in relation to the second, third and fourth memory devices NVM_2 through NVM_4 may executed in a temporarily overlapping manner. These similarly configured operations will each include a read operation, a data output operation, a data input operation, and a program operation. Hence, the first through fourth memory devices NVM_1 to NVM_4 may perform respective copy-back operations using an interleaving approach. As a result, a second data output operation and/or a second data input operation related to the second memory device NVM_2 may be performed simultaneously (at least in part) with the first program operation related to the first memory device NVM_1.

Thus, the controller 110 may control definition of the host transmission and reception operation (Host_op) to include a data output operation, and a data input operation for each of a plurality of memory devices also executing a read operation and a program operation. Now, assuming that the physical and operational specifications for the memory system 100 is defined (using for example empirically derived evidence), an expected peak operating current associated with the foregoing collection of operations may be fairly well predicted. For example, assuming the use of firmware in implementing the peak current manager 117, accurate peak current information for each one of the above-described operations may be used to calculate expected peak operating current for any time during the overlapping execution of first through fourth data output operation(s), data input operation(s), read operation(s), and/or program operation(s).

For example, it is assumed in the context of one more specific example that peak current associated with the host transmission and reception operation (Host_op) is about 20 mA; peak current associated with the data output operation is about 200 mA; peak current associated with the data input operation is about 50 mA; peak current associated with the read operation is about 70 mA, and peak current associated with the program operation is about 70 mA. As compared with other (sub-)operations implicated in the exemplary copy-back operation, the data output operation consumes a notably greater amount of current, largely because of circuitry necessary to perform one or more ECC operation(s). Thus, the peak current associated with the data output operation in the working example is more than twice as high as the corresponding program operation. Referring to FIG. 4, a period (tPmax) may be identified with a “maximum peak current” condition for the memory system 100 wherein a fourth (sequentially occurring) data output period (tDOUT) associated with the fourth memory device NVM_4 occurs simultaneously with one or more program operations and the host transmission and reception operation (Host_op) established between the controller 110 and host.

Thus, specifically referring to the example of FIG. 4, a data output operation associated with the fourth memory device NVM_4, as well as program operations associated with the first, second and third memory devices NVM_1 through NVM_3 may be simultaneously executed. Using the assumptions made above, the peak operating current (Iop) for the memory system 110 will be about 430 mA during this time period. Assuming a desired maximum peak operating current of for the memory system 110 of about 300 mA, some control provision regarding the execution timing or delay of one or more (sub-)operations described above should be made. For example, the memory system 100 may avoid a maximum operating current overage condition by reducing the number of simultaneously performed (overlapping execution) copy-back operations, or by changing a period wherein a data output operation is performed at the same time as one or more program operations. In this manner, the memory system 100 may control the level of peak operating current (Iop) in view of a peak current reference (or target) (Iref) by (e.g.,) varying the execution timing of certain operations that would otherwise be simultaneously executed in a prejudicial or stressful manner.

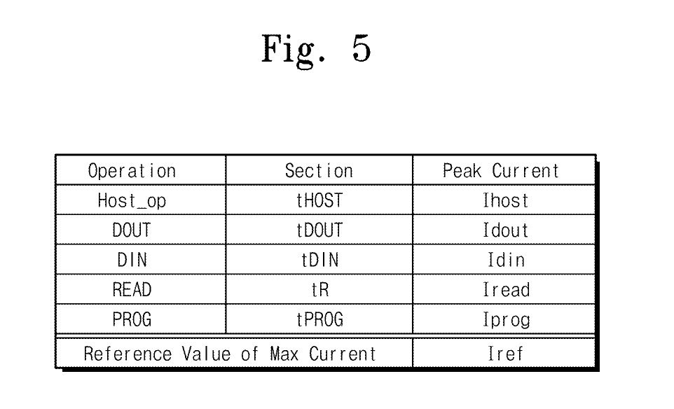

FIG. 5 is a table listing exemplary peak current values for certain operations described above in relation to the memory system 100. Assuming the use of a firmware-based peak current manager 117, one or more lookup table(s) may be provided with expected (or estimated, or modeled) peak current values for various operations (or sub-operations). The peak current manager 117 may also store one or more peak reference current (Iref) values. The controller 110 of FIG. 1 may then be used to calculate or derive for any moment in operational time the peak operating current (Iop) expected form the memory system 100 using the one or more lookup table(s).

Further, the controller 110 may be used to compare the peak operating current (Iop) with the reference peak current (Iref) in order to determine whether a next sequentially occurring operation should be added to the present operational load, and if so, what type of operation may be added as the next operation.

Referring to FIG. 5, the peak current manager 117 may be used to determine an expected peak operating current (Iop) for a given period of time, such as a period of time defined by a host transmission and reception operation (Host_op) (e.g., a period of time during which a “host transmission” and “memory system reception” may occur (e.g., tHOST in FIG. 4). Thus determination will be made in view of a current operational load of simultaneously executed operations for the memory system 100. The description provided above in relation to FIG. 4 assumes, for example, the simultaneous execution of four (4) copy-back operations in relation to four nonvolatile memory devices.

Current consumption for the memory system 100 may be determined, for example, by summing the respective peak currents expected by the coming operational load of operations for both the controller 110 and the nonvolatile memory devices 120. Thus, a peak operating current for the memory system 100 will depend on (1) the number of operations to be simultaneously executed; (2) the nature of the particular operations to be simultaneously executed; and (3) and current consumption requirements (or expectations) for memory system components involved in the simultaneous execution of the operations.

Once the peak operating current expected in view of the foregoing is determined, the controller 110 operating in conjunction with the peak current manager 117 may be used, if necessary, to change the number of operations to be simultaneously executed, the nature or type of at least one of the operations to be simultaneously executed, and/or a mode of operation for one or more memory system components to be used during the simultaneous execution of the operations. Any one, more than one or all of these factors may be changed by the controller 110 in view of a calculated peak operating current (Iop) and a corresponding peak current reference (Iref).

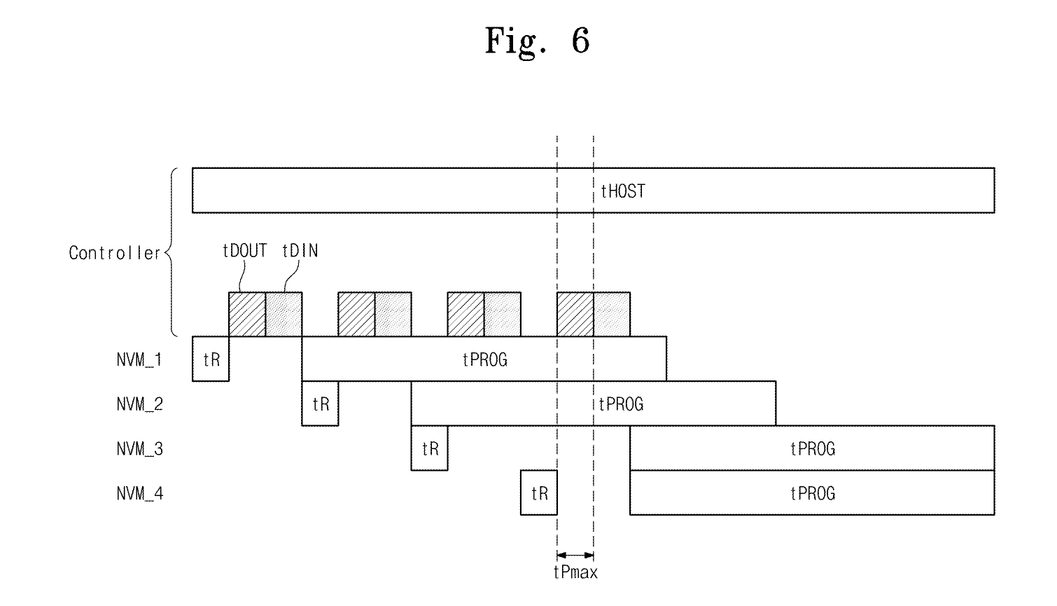

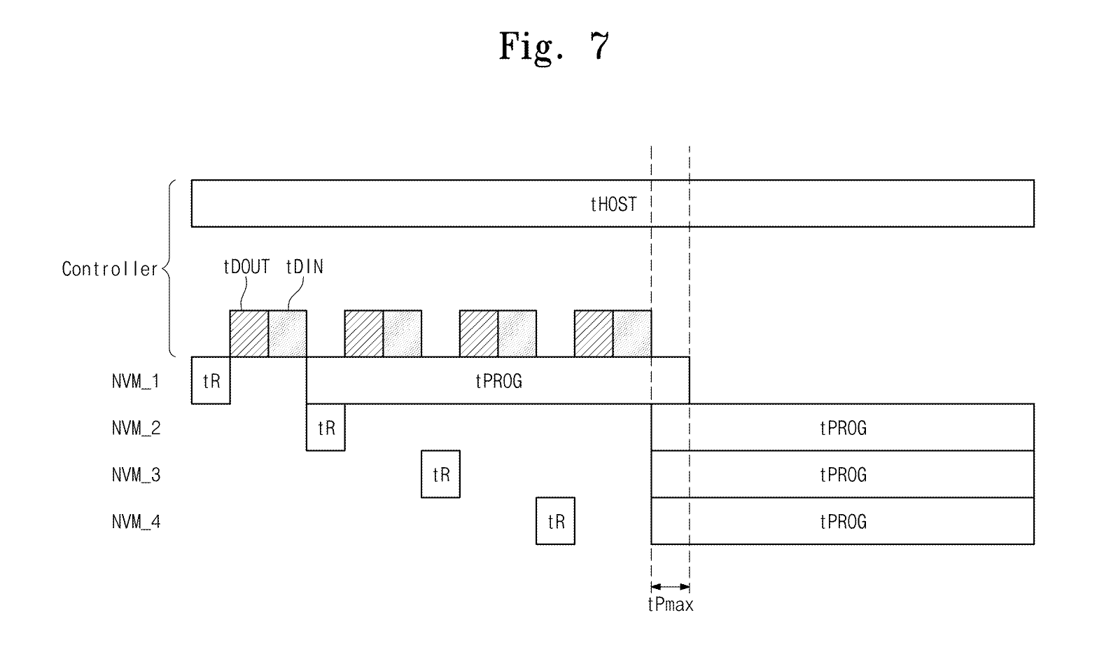

FIG. 6 is another conceptual timing diagram illustrating by way of comparison with FIG. 4 the simultaneous execution of multiple copy-back operations in the memory system 100 when managed according to an embodiment of the inventive concept.

Referring to FIGS. 1, 2, 3, 4, and 6, similar memory system assumptions are made for the following description as were made in the description presented in relation to FIG. 4. That is, memory system 100 again includes four nonvolatile memory devices (e.g., NVM_1, NVM_2, NVM_3, and NVM_4) 120 connected via channel 116, wherein each one of the nonvolatile memory devices NVM_1, NVM_2, NVM_3, and NVM_4 may be accessed using an interleaving approach. The execution of multiple copy-back operations like those described in relation to FIG. 4 is also assumed. Since the duration of the host transmission and memory system reception operation (Host_op) does not influence or determine period(s) wherein maximum peak operating currents will be generated, the peak current (Iprog) associated with the host transmission and memory system reception operation (Host_op) will not be deemed to decide the reference peak current (Iref).

In relation to the operational load illustrated in FIG. 6, the reference peak current (Iref) may be set to be greater than the sum of twice the peak current (Iprog) associated with the host transmission and memory system operation, and a peak current (Idout) associated the data output operation may be set to be less than the sum of three times the peak current (Iprog) for the host transmission and memory system reception operation (Host-op). For example, again assuming a peak current for the data output operation of about 200 mA, peak current for the data input operation of about 50 mA, and peak current for the program operation of about 70 mA, then a peak operating current (Iop) may be expected at about 340 mA during a period of time when the fourth data output operation associated with the fourth memory device NVM_4 is being executed. This being the case, a reference peak current (Iref) of between about 360 mA to 410 mA may be determined. In this case, a maximum value for the peak operating current (Iop) will remain well below the comparative maximum value of the peak operating current (Iop) for the example described in relation to FIG. 4.

That is, in the example illustrated in FIG. 6, the memory system 100 performs a read operation of the memory device NVM_1. The memory system 100 carried out a data output operation of the memory device NVM_1. The memory system 100 executes a data input operation of the memory device NVM_1. After performing the data input operation of the memory device NVM_1, the memory system 100 compares the peak operating current (Iop) with the reference peak current Iref. The peak operating current (Iop) may be decided by a sum of a peak current (Iprog) of a program operation of the memory device NVM_1 and a peak current Idout of a data output operation of the memory device NVM_2. Since the peak operating current (Iop) is below the reference peak current Iref, the memory system 100 performs a program operation of the memory device NMV1 and a read operation of the memory device NVM_2 at the same time.

The memory system 100 perform a read operation, a data output operation, and a data input operation of the memory device NVM_2 in the same manner as described with reference to the memory device NVM_1. After performing the data input operation of the memory device NVM_2, the memory system 100 again compares the peak operating current (Iop) with the reference peak current Iref. In this case, the peak operating current (Iop) may be decided by a sum of peak currents (Iprog) of program operations of the memory devices NVM_1 and NVM_2 and a peak current Idout of a data output operation of the memory device NVM_3. Since the peak operating current (Iop) is below the reference peak current Iref, the memory system 100 performs a program operation of the memory device NMV2 and a read operation of the memory device NVM_3 at the same time.

Likewise, after performing the data input operation of the memory device NVM_3, the memory system 100 again compares the peak operating current (Iop) with the reference peak current Iref. In this case, the peak operating current (Iop) may be decided by a sum of peak currents (Iprog) of program operations of the memory devices NVM_1, NVM_2, and NVM_3 and a peak current Idout of a data output operation of the memory device NVM_4. Since the peak operating current (Iop) is greater than or equal to the reference peak current Iref, the memory system 100 performs a read operation of the memory device NVM_4 without performing a program operation of the memory device NMV3. After a data input operation of the memory device NVM_4 is performed, the memory system 100 carries out a program operation of the memory device NVM_3.

As described above, the memory system 100 compares a peak operating current (Iop) with a reference peak current (Iref) to decide which operation should be performed as a next operation.

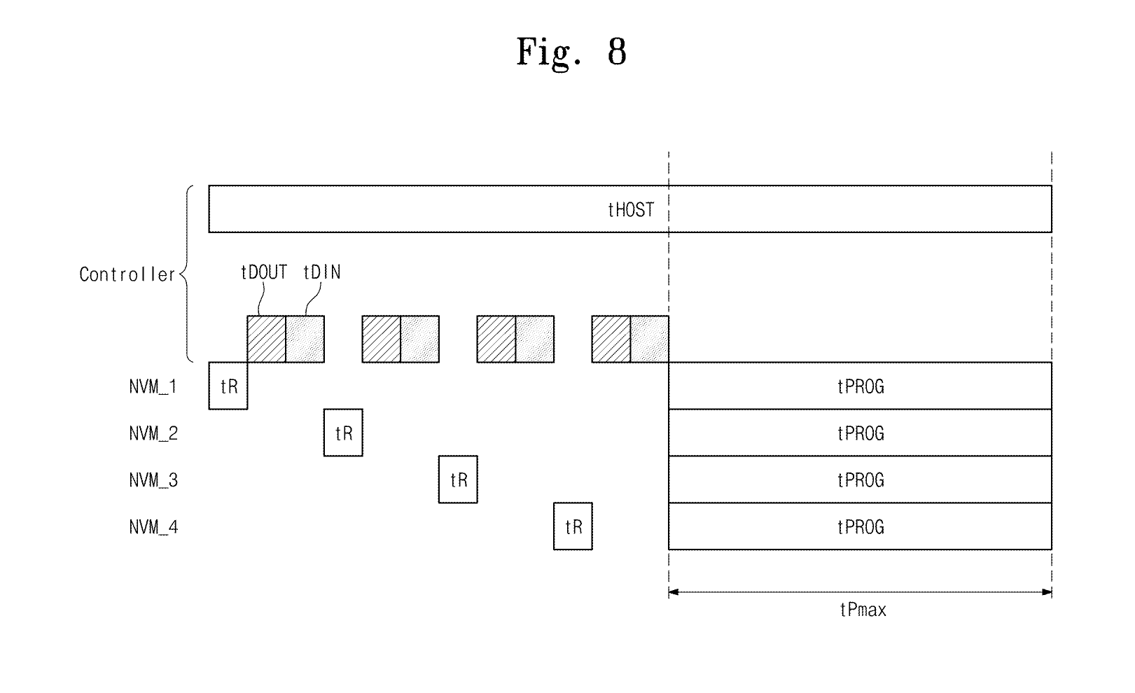

FIG. 7 is still another conceptual timing diagram illustrating by way of comparison with FIGS. 4 and 6 the simultaneous execution of multiple copy-back operations in the memory system 100 when managed according to an embodiment of the inventive concept.

Referring to FIG. 7, program operations of memory devices NVM_2, NVM_3, and NVM_4 commence after a data input operation of a memory device NVM_4 is executed. A memory system 100 (refer to FIG. 1) operates in the same manner as described with reference to FIG. 6, and a description thereof is thus omitted.

In FIG. 7, a reference peak current (Iref) is set to be greater than a sum of a peak current (Iprog) of a program operation and a peak current Idout of a data output operation and less than a sum of twice a peak current (Iprog) of a program operation and a peak current Idout of a data output operation. After performing a data input operation of the memory device NVM_2, the peak operating current (Iop) is set to a sum of peak currents of program operations of memory devices NVM_1 and NVM2 and a peak current Idout of a data output operation of a memory device NVM_3 to be performed next. The peak operating current (Iop) may be greater than or equal to the reference peak current Iref. Thus, the memory system 100 performs a read operation of the memory device NVM_3 without performing a program operation of the memory device NMV4. After a data input operation of the memory device NVM_4 is performed, the memory system 100 carries out program operations of the memory devices NVM_2 to NVM_4 at the same time.

Thus, a period where program operations of the memory devices NVM_2 to NVM_4 are performed may become a period tPmax where a peak current is generated. A maximum value of the peak operating current (Iop) may be smaller than that of a peak operating current (Iop) shown in FIG. 4.

FIG. 8 is still another conceptual timing diagram illustrating by way of comparison with FIGS. 4, 6 and 7, the simultaneous execution of multiple copy-back operations in the memory system 100 when managed according to an embodiment of the inventive concept.

Referring to FIG. 8, program operations of memory devices NVM_1, NVM_2, NVM_3, and NVM_4 commence after a data input operation of a memory device NVM_4 is executed. A memory system 100 (refer to FIG. 1) operates in the same manner as described with reference to FIG. 6, and a description thereof is thus omitted.

In FIG. 8, a reference peak current (Iref) is set to be greater than a sum of a peak current Idout of a data output operation and smaller than a sum of a peak current (Iprog) of a program operation and a peak current Idout of a data output operation. After performing a data input operation of the memory device NVM_1, the peak operating current (Iop) is set to a sum of a peak current (Iprog) of a program operation of a memory device NVM_1 and a peak current Idout of a data output operation of a memory device NVM_2 to be performed next. The peak operating current (Iop) may be greater than or equal to the reference peak current Iref. Thus, the memory system 100 performs a read operation of the memory device NVM_2 without performing a program operation of the memory device NMV1. After a data input operation of the memory device NVM_4 is performed, the memory system 100 carries out program operations of the memory devices NVM_1 to NVM_4 at the same time.

Thus, a period where program operations of the memory devices NVM_1 to NVM_4 are performed may become a period tPmax where a peak current is generated. A maximum value of the peak operating current (Iop) may be smaller than that of a peak operating current (Iop) shown in FIG. 4.

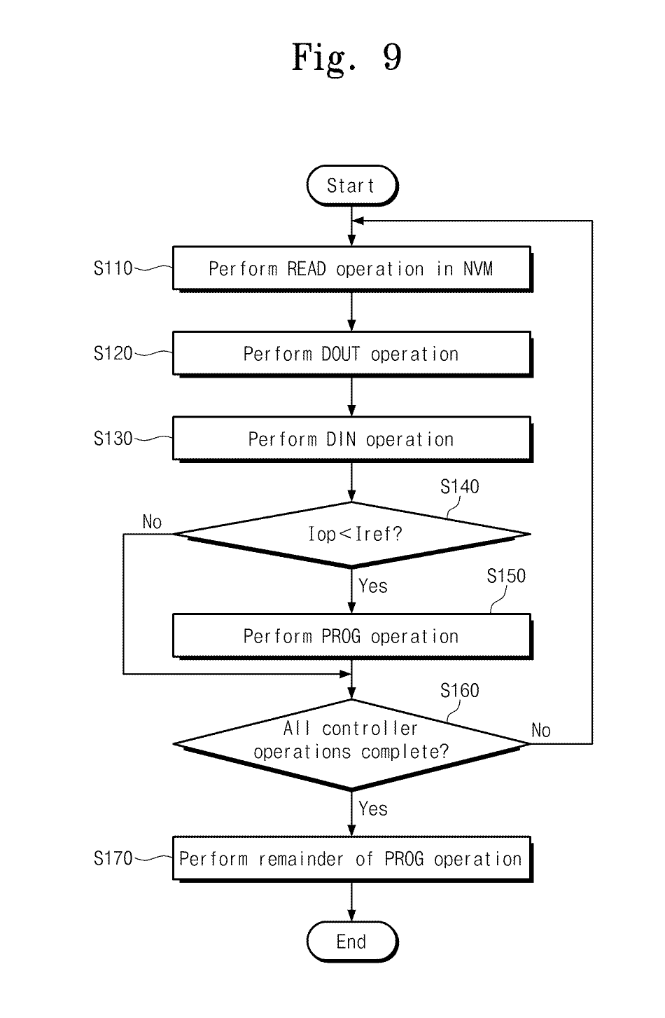

FIG. 9 is a flow chart summarizing a method enabling the execution of multiple copy-back operations in a memory system according to certain embodiments of the inventive concept. Referring to FIGS. 1, 2, 3, and 9, the memory system 100 compares a peak operating current (Iop) with a reference peak current (Iref) to determine whether or not and/or what kind operation should next be performed. Here again, the peak operating current (Iop) may be a sum of peak currents for the multiple simultaneously executed operations associated with the controller 110 and nonvolatile memory devices 120. Memory system 100 is assumed to include four memory devices NVM_1 to NVM4 connected via channel 116 and operated in an interleaved manner. A similar copy-back operation as described above is again assumed.

Thus, the memory system 100 performs a read operation associated with the first memory system NVM_1 (S110). During the read operation, data is read from the first memory device NVM_1 and stored in a buffer memory associated with the first memory device NVM_1.

Then, the memory system 100 executes a data output operation associated with the first memory device NVM_1 (S120). During the data output operation, the data stored in the buffer memory associated with the memory device NVM_1 is transferred to the buffer memory 130 of the controller 110. An error checking and correction (ECC) operation may be executed while the data is being transferred to the buffer memory 130. Also, the controller 110 may perform additional operations flash I/F based ECC operation(s). In this case, the data output operation is likely to cause a high level of current consumption.

Then, the memory system 100 executes a data input operation associated with the first memory device NVM_1 (S130). During the data input operation, data stored in the buffer memory 130 by the data output operation is transferred back to the buffer memory associated with the first memory device NVM_1.

The memory system 100 now compares the peak operating current (Iop) with a reference peak current Iref (S140). The peak operating current (Iop) may be a sum of a peak current (Iprog) of a program operation of the memory device NVM_1 and a peak current of a data output operation of the memory device to be performed next. If the peak operating current (Iop) is less than the reference peak current Iref, the method proceeds to step S150. However, if the peak operating current (Iop) is greater than the reference peak current Iref, the memory system 100 will not perform the program operation associated with the first memory device NVM_1, but instead will method proceed to step S160.

As a consequence of determining that the peak operating current (Iop) is less than the reference peak current (Iref) (S150=Yes), the memory system 100 performs a program operation associated with the first memory device NVM_1. During the program operation, data stored in the buffer memory associated with the first memory device NVM_1 is programmed to a designated and previously erased of the first memory device NVM_1.

Otherwise, the memory system 100 determines whether or not all current operations determined by the controller 110 have been completed (S160). Steps S110 to S150 will be iteratively performed for all requisite memory devices (e.g.,) NVM_2, NVM_3, and NVM_4 not yet processed. Once all controller designated operations are complete (S160=yes) and since all read operations, data output operations, and data input operations associated with each of the memory devices NVM_1, NVM_2, NVM_3, and NVM_4 are complete, the memory system 100 may perform such program operations previously skipped (S140=No), from among program operations of the memory devices NVM_1, NVM_2, NVM_3, and NVM_4 (S170).

As described above, the memory system 100 compares a peak operating current (Iop) with a reference peak current (Iref) to determine whether a next called-for program operation should be executed as a next operation. To reduce the maximum value of the peak operating current (Iop), the memory system 100 may, as necessary, control one or more program operations associated with the memory devices NVM_1 to NVM_4. Certain of these program operations may be delayed in execution until after all read operations, data output operations, and data input operations associated with the memory devices NVM_1 to NVM_4 have been completed. For accomplish this in the memory system 100, the operation of the controller 110 and nonvolatile memory devices 120 may be controlled such that a maximum peak current is not produced during one or more data output period(s) (tDOUT). Thus, it is possible to reduce a maximum value of the peak operating current Iop.

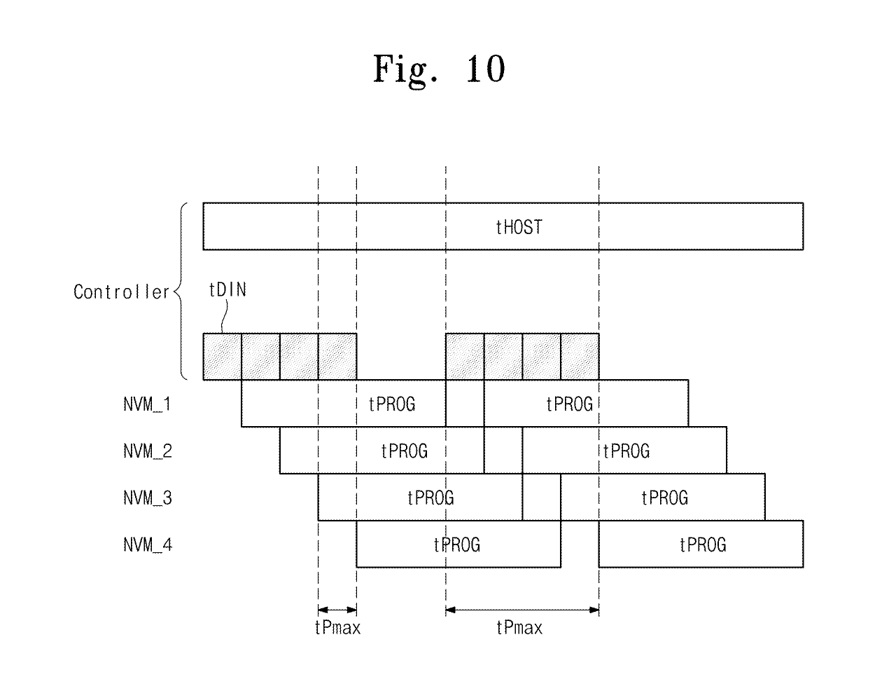

FIG. 10 is still another conceptual timing diagram illustrating the simultaneous execution of multiple write operations in the memory system 100.

Referring to FIGS. 1, 2, 3 and 10, operations of the controller 110 and nonvolatile memory devices 120 are performed simultaneously or sequentially. Below, it is assumed that the nonvolatile memory devices 120 include four memory devices NVM_1 to NVM_4. This may mean that a flash interface 115 controls the four memory devices NVM_1 to NVM_4 in a 4-way interleaving manner.

FIG. 10 illustrates execution of a write operation in the memory system 100. The controller 110 receives a write request and corresponding write data from the host. A host transmission and memory system reception operation (Host_op) between the controller 110 and the host may or may not be generated at any time. In the worst case, the host transmission and reception operation (Host_op) may be performed during all periods. The host transmission and reception operation (Host_op) may be executed during a host transmission and reception period (tHOST).

A first write operation directed to the first memory device NVM_1 includes a data input operation and a program operation. The memory system 100 temporarily stores write data received from the host in the buffer memory 130.

During the data input operation, write data transferred from the host and stored in the buffer memory 130 is transferred to a buffer memory associated with the first memory device NVM_1. The data input operation is performed during a data input period (tDIN).

During the first program operation, first write data stored in the buffer memory associated with the first memory device NVM_1 will be programmed in a previously erased block of the first memory device NVM_1. The first program operation commences after the first write data input operation is ended. The first program operation is performed during a first program period (tPROG).

Like the first write operation directed to the first memory device NVM_1, respective second through fourth write operations directed to the second through fourth memory devices NVM_2 to NVM_4 may include a corresponding data input operation and a program operation. The memory devices NVM_1 to NVM_4 may perform their write back operations according to an interleaving manner. Thus, a data input operation of the memory device NVM_2 may be performed at the same time with the program operation of the memory device NVM_1.

The host transmission and reception operation (Host_op) and the data input operation may be executed by the controller 110, and the program operation may be carried out by each of the memory devices NVM_1 to NVM_4. If a physical specification of the memory system 100 is defined, expected peak operating current may be predicted for each of the above-described operations: the host transmission and reception operation (Host_op), the data input operation, and the program operation. Again assuming a firmware based peak current manager, peak current information may be referenced in relation to the above-described operations: the host transmission and reception operation (Host_op), the data input operation, and the program operation.

For example, a peak operating current for the host transmission and reception operation (Host_op) may be about 100 mA, peak operating current for the data input operation may be about 1500 mA, and peak operating current for the program operation may be about 70 mA. During the write operation, a maximum peak operating current of the memory system 100 may occur when a data input operation of one memory device and program operations of three memory devices are performed at the same time. At this time, the peak operating current (Iop) may be about 360 mA. As understood from FIG. 10, a period where a data input operation of one memory device and program operations of three memory devices are performed at the same time may become a period (tPmax) where a peak current of the memory system 100 is produced. During the period (tPmax), the host transmission and reception operation (Host_op), a data input operation of one memory device, and program operations of three memory devices are performed at the same time. If a data input operation of one memory device and program operations of two memory devices are performed at the same time, the peak operating current (Iop) of the memory system 100 may be reduced. A maximum value of the peak operating current (Iop) may be reduced by changing a period where a data input operation and program operations of the memory devices NVM_1 to NVM_4 are performed at the same time. The memory system 100 of the inventive concept may reduce a maximum value of the peak operating current (Iop) by varying start points in time of program operations of the memory devices NVM_1 to NVM_4.

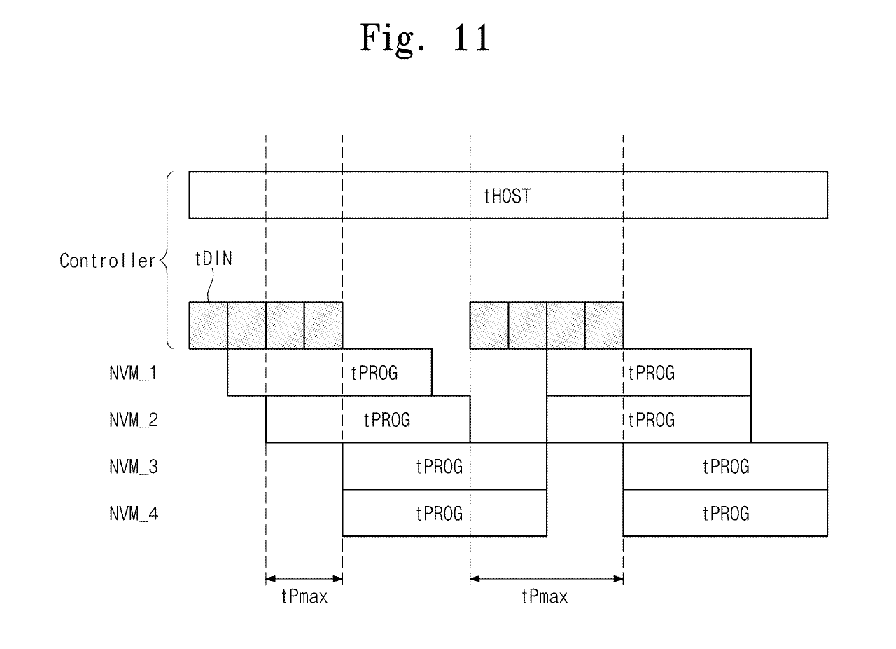

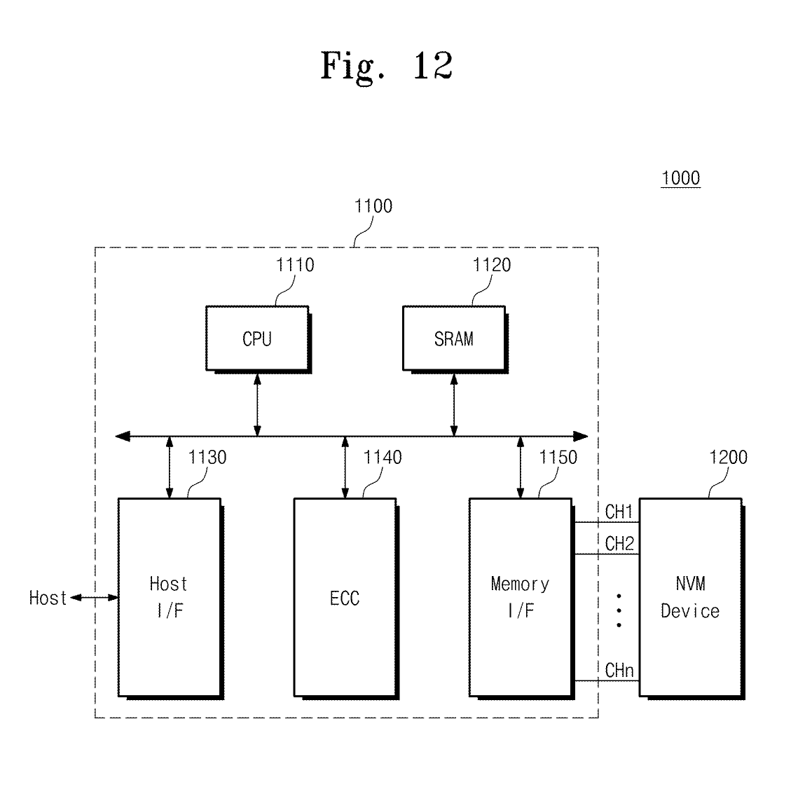

FIG. 11 is still another conceptual timing diagram illustrating by way of comparison with FIG. 10, the simultaneous execution of multiple write operations in the memory system 100 when managed according to an embodiment of the inventive concept.

Referring to FIGS. 1, 2, 3, 10 and 11, the memory system 100 divides write operations associated with first through fourth memory devices NVM_1 to NVM_4 into two groups. A write operation, as described with reference to FIG. 10, contains a data input operation and a program operation. Also, since a host transmission and reception operation (Host_op) does not influence a period where a maximum peak operating current is generated, a peak current (Iprog) of the host transmission and reception operation (Host_op) is not considered to decide a reference peak current Iref.

During a first write operation, program operations of the memory devices NVM_3 and NVM_4 commence after a data input operation of the memory device NVM_4 is carried out. The memory system 100 compares a peak operating current (Iop) with a reference peak current (Iref) to decide an operation to be performed next. The peak operating current (Iop) may mean a sum of peak currents of operations of the controller 110 and nonvolatile memory devices 120 that are simultaneously performed.

In FIG. 11, the reference peak current (Iref) is set to be greater than a sum of twice a peak current (Iprog) of a program operation and a peak current Idout of a data output operation and smaller than a sum of three times a peak current (Iprog) of a program operation and a peak current Idout of a data output operation. For example, a peak current of a data input operation may be about 150 mA, and a peak current of a program operation may be about 70 mA. A peak operating current (Iop) may be about 290 mA while a data input operation of the memory device NVM_4 is carried out. Thus, the reference peak current (Iref) may be decided between 290 mA and 360 mA. In this case, a maximum value of the peak operating current (Iop) may be below a maximum value of a peak operating current (Iop) shown in FIG. 10.

The memory system 100 executes a data input operation of the memory device NVM_1. After performing the data input operation of the memory device NVM_1, the memory system 100 compares the peak operating current (Iop) with the reference peak current Iref. The peak operating current (Iop) may be decided by a sum of a peak current (Iprog) of a program operation of the memory device NVM_1 and a peak current Idin of a data input operation of the memory device NVM_2. Since the peak operating current (Iop) is below the reference peak current Iref, the memory system 100 performs a program operation of the memory device NMV_1 and a read operation of the memory device NVM_2 at the same time.

The memory system 100 executes a data input operation of the memory device NVM_2 in the same manner as described with reference to the memory device NVM_1. After performing the data input operation of the memory device NVM_2, the memory system 100 again compares the peak operating current (Iop) with the reference peak current Iref. In this case, the peak operating current (Iop) may be decided by a sum of peak currents (Iprog) of program operations of the memory devices NVM_1 and NVM_2 and a peak current Idin of a data input operation of the memory device NVM_3 to be performed next. Since the peak operating current (Iop) is below reference peak current Iref, the memory system 100 performs a program operation of the memory device NMV_2 and a data input operation of the memory device NVM_3 at the same time.

Likewise, after performing the data input operation of the memory device NVM_3, the memory system 100 again compares the peak operating current (Iop) with the reference peak current Iref. In this case, the peak operating current (Iop) may be decided by a sum of peak currents (Iprog) of program operations of the memory devices NVM_1, NVM_2, and NVM_3 and a peak current Idout of a data input operation of the memory device NVM_4 to be performed next. Since the peak operating current (Iop) is greater than or equal to the reference peak current Iref, the memory system 100 performs a data input operation of the memory device NVM_4 without performing a program operation of the memory device NMV3. After a data input operation of the memory device NVM_4 is performed, the memory system 100 carries out a program operation of the memory device NVM_3.

During a second write operation, the memory system 100 compares the peak operating current (Iop) with the reference peak current (Iref) to control start points in time of program operations of the memory devices NVM_1, NVM_2, NVM_3, and NVM_4, in the same manner as the first write operation. Under a control of the memory system 100, there are simultaneously performed a data input operation of one memory device and program operations of two memory devices. Thus, program operations of the memory devices NVM_1 and NVM_2 commence after a data input operation of the memory device NVM_2 is performed. Also, program operations of the memory devices NVM_3 and NVM_4 commence after a data input operation of the memory device NVM_4 is performed.

As described above, the memory system 100 compares a peak operating current (Iop) with a reference peak current (Iref) to decide an operation to be performed next. The peak operating current (Iop) may mean a sum of peak currents of operations of the controller 110 and nonvolatile memory devices 120 that are simultaneously performed. The peak current manager may include information about peak currents of operations that the controller 110 and the nonvolatile memory devices 120 execute. The controller 110 make comparison between the peak operating current (Iop) and the reference peak current Iref, based on the information about peak currents.

Current consumption of the memory system 100 may be decided by a sum of a current, which the controller 110 consumes, and a current which the nonvolatile memory devices 120 consume. Thus, a peak current of the memory system 100 may depend on operations that are simultaneously performed by the controller 110 and the nonvolatile memory devices 120. The controller 110 may change the number of operations that are simultaneously performed by the controller 110 and the nonvolatile memory devices 120 using a peak current manager, thereby reducing a maximum value of a peak current that the memory system 100 produces.

It is possible to perform a copy-back operation described with reference to FIGS. 6, 7 and 8 and a write operation described with reference to FIGS. 10 and 11 together. In this case, a reference peak current (Iref) is set over the copy-back operation and the write operation, based on an operating point in time when a maximum peak operating current (Iop) occurs. The memory system 100 compares the peak operating current (Iop) with the reference peak current (Iref) to vary the number of operations to be simultaneously performed.

FIG. 12 is a block diagram illustrating a memory system according to another embodiment of the inventive concept. Referring to FIG. 12, a memory system 1000 includes a memory controller 1100 and a nonvolatile memory device 1200.

The memory controller 1100 may be configured to control the nonvolatile memory device 1200. The memory controller 1100 and the nonvolatile memory device 1200 may constitute a memory card or a solid state drive (SSD). An SRAM 1120 may be used as a working memory of a central processing unit (CPU) 1110. A host interface 1130 may include a data exchange protocol of a host connected with the memory system 1000. An ECC block 1140 is configured to detect and correct errors included in data read out from the nonvolatile memory device 1200. A memory interface 1150 may interface with the nonvolatile memory device 1200. The memory interface 1150 is connected to the nonvolatile memory device 1200 through a plurality of channels. The CPU 1110 executes an overall control operation for data exchange of the memory controller 1100. Although not shown in FIG. 12, the memory system 1000 may further include ROM which stores code data for interfacing with the host.

The memory controller 1100 compares a peak operating current (Iop) with a reference peak current (Iref) to decide an operation to be performed next. The peak operating current (Iop) may mean a sum of peak currents of operations of the memory controller 1100 and the nonvolatile memory device 1200 that are simultaneously performed. A peak current manager may include information about peak currents of operations that the memory controller 1100 and the nonvolatile memory device 1200 execute. The memory controller 1100 make comparison between the peak operating current (Iop) and the reference peak current Iref, based on the information about peak currents.

Current consumption of the memory system 1000 may be decided by a sum of a current, which the memory controller 1100 consumes, and a current which the nonvolatile memory device 1200 consumes. Thus, a peak current of the memory system 1000 may depend on operations that are simultaneously performed by the memory controller 1100 and the nonvolatile memory device 1200. The memory controller 1100 may change the number of operations that are simultaneously performed by the memory controller 1100 and the nonvolatile memory device 1200 using a peak current manager, thereby reducing a maximum value of a peak current that the memory system 1000 produces.

The nonvolatile memory device 1200 may be implemented with a multi-chip package that includes a plurality of flash memory chips. With the above description, the memory system 1000 of the inventive concept may be used as a storage medium with low error probability and high reliability. In particular, a memory system such as a solid state drive may be equipped with a flash memory device. In this case, the memory controller 1100 is configured to communicate with an external device (e.g., a host) through one of a variety of interface protocols, such as USB, MMC, PCI-E, SAS, SATA, PATA, SCSI, ESDI, and IDE. Also, the memory controller 1100 may comprise components for executing random calculation.

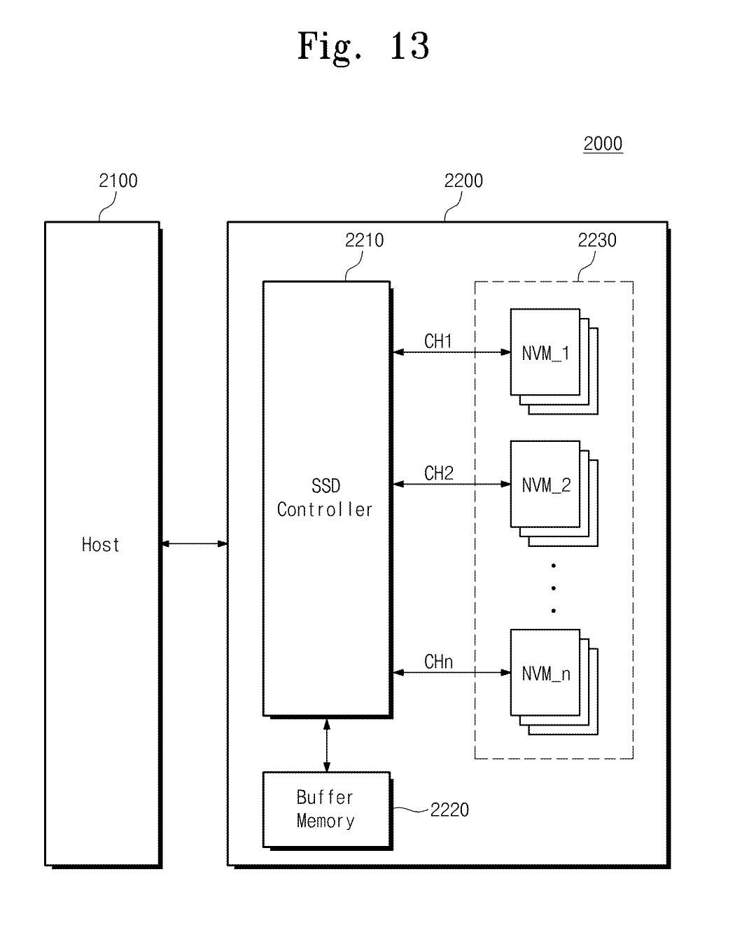

FIG. 13 is a block diagram illustrating a solid state drive according to an embodiment of the inventive concept. Referring to FIG. 13, a solid state drive (hereinafter, referred to as SSD) system 2000 includes a host 2100 and an SSD 2200. The SSD 2200 includes an SSD controller 2210, a buffer memory 2220, and a nonvolatile memory device 2230.

The SSD controller 2210 provides physical interconnection between the host 2100 and the SSD 2200. The SSD controller 2210 provides an interface with the SSD 2200 corresponding to a bus format of the host 2100. In particular, the SSD controller 2210 decodes a command provided from the host 2100 and accesses the nonvolatile memory device 2230 based on the decoding result. The bus format of the host 2100 may include USB (Universal Serial Bus), SCSI (Small Computer System Interface), PCI express, ATA, PATA (Parallel ATA), SATA (Serial ATA), SAS (Serial Attached SCSI), and the like.

The SSD controller 2210 compares a peak operating current (Iop) with a reference peak current (Iref) to decide an operation to be performed next. The peak operating current (Iop) may mean a sum of peak currents of operations of the SSD controller 2210 and the nonvolatile memory device 2230 that are simultaneously performed. The peak current manager may include information about peak currents of operations that the SSD controller 2210 and the nonvolatile memory device 2230 execute. The SSD controller 2210 make comparison between the peak operating current (Iop) and the reference peak current Iref, based on the information about peak currents.

Current consumption of the SSD system 2000 may be decided by a sum of a current, which the SSD controller 2210 consumes, and a current which the nonvolatile memory device 2230 consumes. Thus, a peak current of the SSD system 2000 may depend on operations that are simultaneously performed by the SSD controller 2210 and the nonvolatile memory device 2230. The SSD controller 2210 may change the number of operations that are simultaneously performed by the SSD controller 2210 and the nonvolatile memory device 2230 using a peak current manager, thereby reducing a maximum value of a peak current that the SSD system 2000 produces.

The buffer memory 2220 temporarily stores write data provided from the host 2100 or data read out from the nonvolatile memory device 2230. In the event that data existing in the nonvolatile memory device 2230 is cached, at a read request of the host 2100, the buffer memory 2220 supports a cache function to provide cached data directly to the host 2100. Typically, a data transfer speed of a bus format (e.g., SATA or SAS) of the host 2100 may be higher than that of a memory channel of the SSD 2200. That is, in the event that an interface speed of the host 2100 is much faster, lowering of the performance due to a speed difference may be minimized by providing the buffer memory 2220 with a large storage capacity.

The buffer memory 2220 may be formed of a synchronous DRAM to provide sufficient buffering to the SSD 2200 used as an auxiliary mass storage device. However, the inventive concepts are not limited thereto.

The nonvolatile memory device 2230 may be provided as a storage medium of the SSD 2200. For example, the nonvolatile memory device 2230 may be formed of a NAND flash memory device with a mass storage capacity. The nonvolatile memory device 2230 is formed of a plurality of memory devices. In this case, memory devices may be connected with the SSD controller 2210 by the channel. There is described an embodiment where as a storage medium, the nonvolatile memory device 2230 is formed of a NAND flash memory. However, the nonvolatile memory device 2230 is not limited to a NAND flash memory device. For example, a storage medium of the SSD 2200 may be formed of a PRAM, an MRAM, a ReRAM, a FRAM, a NOR flash memory, and the like. Further, the inventive concept may be applied to a memory system that uses different types of memory devices together. A volatile memory device (e.g., DRAM) may be provided as a storage medium of the SSD 2200.

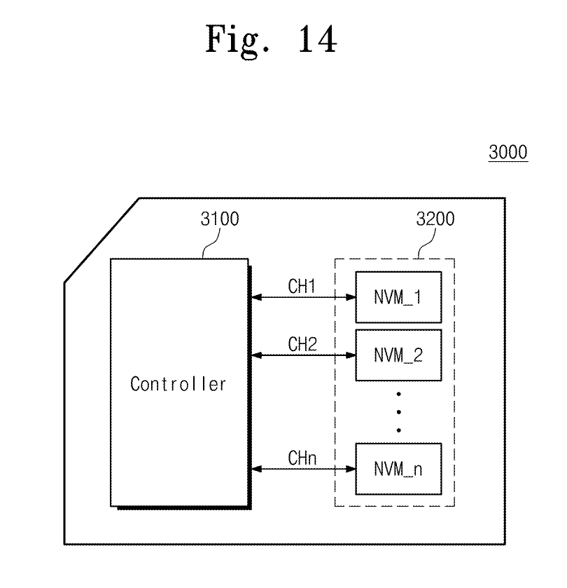

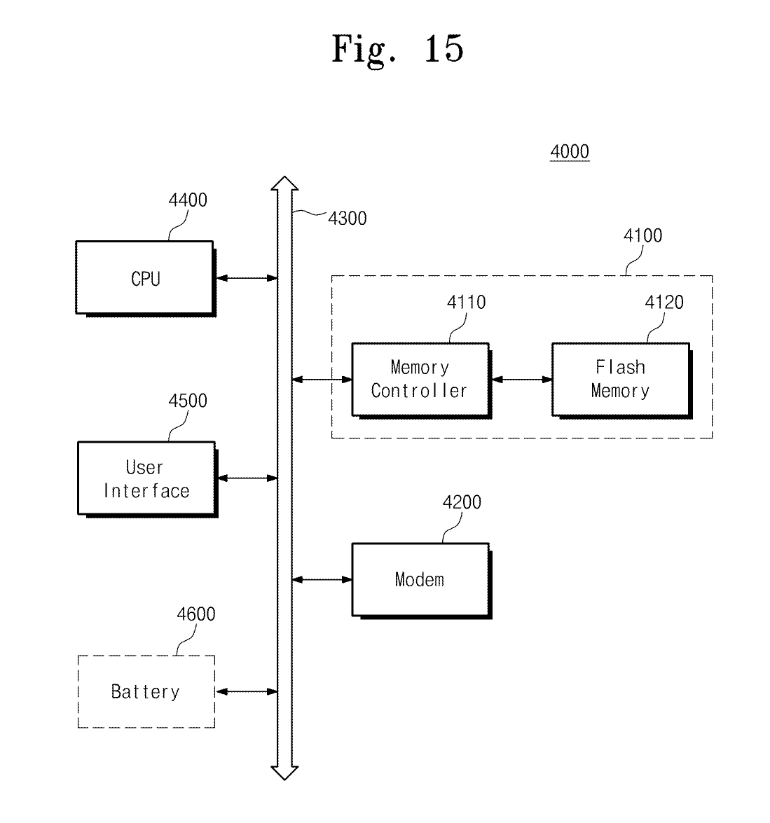

FIG. 14 is a block diagram illustrating a memory card according to an embodiment of the inventive concept. Referring to FIG. 14, a memory card 3000 includes a controller 3100 and a nonvolatile memory device 3200. The controller 3100 and the nonvolatile memory device 3200 are connected through a plurality of channels CH1 to CHn. The nonvolatile memory device 3200 includes a plurality of nonvolatile memories NVM_1 to NVM_n that are connected to the channels CH1 to CHn and are managed independently. The controller 3100 controls the nonvolatile memory device 3200 based on control signals provided from an external device of the memory card 3000. The memory card 3000 is configured substantially the same as a memory system 100 illustrated in FIG. 1.

The controller 3100 is connected to the nonvolatile memory device 3200 through the channels CH1 to CHn. The controller 3100 compares a peak operating current (Iop) with a reference peak current (Iref) to decide an operation to be performed next. The peak operating current (Iop) may mean a sum of peak currents of operations of the controller 3100 and the nonvolatile memory device 3200 that are simultaneously performed. The peak current manager may include information about peak currents of operations that the controller 3100 and the nonvolatile memory device 3200 execute. The controller 3100 make comparison between the peak operating current (Iop) and the reference peak current Iref, based on the information about peak currents.

Current consumption of the memory card 3000 may be decided by a sum of a current, which the controller 3100 consumes, and a current which the nonvolatile memory device 3200 consumes. Thus, a peak current of the memory card 3000 may depend on operations that are simultaneously performed by the controller 3100 and the nonvolatile memory device 3200. The controller 3100 may change the number of operations that are simultaneously performed by the controller 3100 and the nonvolatile memory device 3200 using a peak current manager, thereby reducing a maximum value of a peak current that the memory card 3000 produces.

The memory card 3000 is mounted on information processing devices, such as a digital camera, a PMP, a mobile phone, a notebook computer, and so on. The memory card 3000 may be used as a Multimedia Card (MMC), a Secure Digital (SD) card, a micro SD card, a memory stick, an ID card, a PCMCIA card, a chip card, a USB card, a smart card, a Compact Flash (CF) card, and so on.

FIG. 15 is a block diagram schematically illustrating a computing system according to an embodiment of the inventive concept. Referring to FIG. 15, a computing system 4000 according to an embodiment of the inventive concept comprises a nonvolatile storage device 4100, a central processing unit (CPU) 4400, a user interface 4500, and a modem 4200, such as a baseband chip, which are electrically connected to a system bus 4300. The nonvolatile storage device 4100 is configured substantially the same as a memory system 100 illustrated in FIG. 1.

If the computing system 4000 is a mobile device, it further comprises a battery 4600 for supplying an operating voltage to the computing system 4000. Although not show in FIG. 15, the computing system 4000 may further comprise an application chipset, a Camera Image Processor (CIS), a mobile DRAM, etc.

A memory controller 4110 compares a peak operating current (Iop) with a reference peak current (Iref) to decide an operation to be performed next. The peak operating current (Iop) may mean a sum of peak currents of operations of the memory controller 4110 and a flash memory device 4120 that are simultaneously performed. The peak current manager may include information about peak currents of operations that the memory controller 4110 and the flash memory device 4120 execute. The memory controller 4110 make comparison between the peak operating current (Iop) and the reference peak current Iref, based on the information about peak currents.

Current consumption of the storage device 4100 may be decided by a sum of a current, which the memory controller 4110 consumes, and a current which the flash memory device 4120 consumes. Thus, a peak current of the storage device 4100 may depend on operations that are simultaneously performed by the memory controller 4110 and the flash memory device 4120. The memory controller 4110 may change the number of operations that are simultaneously performed by the memory controller 4110 and the flash memory device 4120 using a peak current manager, thereby reducing a maximum value of a peak current that the storage device 4100 produces.

A nonvolatile memory device and/or a memory controller according to the inventive concept may be packaged according to any of a variety of different packaging technologies. Examples of such packaging technologies may include PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

While the inventive concept has been described with reference to certain embodiments, it will be apparent to those skilled in the art that various changes and modifications may be made without departing from the spirit and scope of the present invention. Therefore, it should be understood that the above embodiments are not limiting, but illustrative.

What is claimed is:

1. A memory system comprising:
a plurality of nonvolatile memory devices (NVM) commonly connected to a controller via a channel, each NVM being configured to receive write data from the controller according to an data interleaving approach and to independently execute a program operation with respect to other of the NVM, wherein
the controller is configured to respectively access the NVM according to the data interleaving approach and to control the execution of program operations by the NVM,
the controller is further configured to determine a number of the program operations that are to be simultaneously executed by the NVM in conjunction with at least one additional operation upon comparing a peak operating current associated with a sum of respective peak operating currents for the number of program operations and the at least one additional operation with a reference peak current.

2. The memory system of claim 1, wherein the at least one additional operation is executed between the controller and each NVM.

3. The memory system of claim 1, wherein the at least one additional operation is either a data output operation, or a data input operation.

4. The memory system of claim 3, wherein the controller is further configured to execute at least one additional program operation after the number of the program operations is simultaneously executed with the data output operation, and only after the data output operation is complete.

5. The memory system of claim 1, wherein the controller comprises a peak current manager configured to determine the number of program operations that are to be simultaneously executed by the plurality of NVMs in conjunction with the at least one additional operation by summing the respective peak operating currents for the number of program operations and the at least one additional operation.

6. The memory system of claim 5, wherein the peak current manager further comprises a look-up table storing values for the respective peak operating currents for the number of program operations and the at least one additional operation.

7. The memory system of claim 6, wherein the at least one additional operation is one of a data output operation and a data input operation.

8. The memory system of claim 7, wherein a peak operating current for the data output operation is at least twice a peak operating current for one of the number of program operations.

9. The memory system of claim 1, further comprising:
a buffer memory configured to temporarily store write data received from a host.

10. The memory system of claim 9, wherein the controller performs an error checking and correction operation on the write data before execution of a program operation associated with the write data.

11. An operating method for a memory system including a controller and a plurality of nonvolatile memory devices (NVM) commonly connected to the controller having a peak current manager via a channel, the method comprising:
receiving from a host a sequence of copy-back operations in the controller, wherein each one of the copy-back operations is directed to data stored in an interleaved manner across the plurality of NVM, and includes a read operation, data output operation, a data input operation and a data program operation;
using the peak current manager to determine a number of program operations associated with the sequence of copy-back operations that will be simultaneously executed by the plurality of NVMs in conjunction with at least one additional operation by summing respective peak operating currents for the number of program operations and a peak operating current for the at least one additional operation to generate a peak operating current, and thereafter comparing the peak operating current to a reference peak current.

12. The method of claim 11, wherein the at least one additional operation is executed between the controller and each NVM.

13. The method of claim 11, wherein the at least one additional operation is either a data output operation, or a data input operation.

14. The method of claim 13, further comprising:
executing at least one additional program operation after the number of the program operations is simultaneously executed with the data output operation, and only after the data output operation is complete.

15. The method of claim 11, wherein the peak current manager references a look-up table storing values for the respective peak operating currents for the number of program operations and the peak operating current of the at least one additional operation.

16. The method of claim 15, wherein the at least one additional operation is one of a data output operation and a data input operation.

17. The memory system of claim 16, wherein a peak operating current for the data output operation is at least twice a peak operating current for one of the number of program operations.

18. The method of claim 11, further comprising:
temporarily store write data received from the host in a buffer memory.

19. The method of claim 18, further comprising:
performing an error checking and correction operation on the write data before execution of a program operation associated with the write data.

20. An operating method for a memory system including a controller and nonvolatile memory devices (NVM) commonly connected to the controller having a peak current manager via a channel, the method comprising:
receiving from a host a sequence of operations to be executed by the controller in the NVM;
using the peak current manager to determine a number of operations from among the received sequence of operations that will be simultaneously executed by the NVMs in view of a peak operating current equal to a sum of peak operating currents for each one of the number of operations and further in view of a reference peak current.
